(19) United States
(12) Patent Application Publication
(10) Pub. No.: US 2010/0011437 A1
(43) Pub. Date: Jan. 14, 2010

(54) APPARATUS AND METHOD FOR STORING EVENT INFORMATION FOR AN HVAC SYSTEM

(76) Inventors: Michael Courtney, Fort Worth, TX (US); Wojciech Grohman, Little Elm, TX (US); Peter Hrejsa, The Colony, TX (US)

Correspondence Address: HITT GAINES P.C., P.O. BOX 832570, RICHARDSON, TX, 75083, US

(21) Appl. No.: 12/170,298

(22) Filed: Jul. 9, 2008

(51) Int. Cl. H04L 9/32

(52) U.S. Cl. 726/16

(57) ABSTRACT

An apparatus for storing event information relating to operation of an HVAC system includes: (a) at least one memory controller coupled with the HVAC system for receiving the event information; and (b) at least one memory unit coupled with the at least one memory controller. A first memory unit of the at least one memory unit is configured for receiving first selected information of the event information for accessing by at least one of a first party and a second party. A second memory unit of the at least one memory unit is configured for receiving second selected information of the event information for accessing by the second party.

### BACKGROUND OF THE INVENTION

The present invention is directed to heating ventilating air conditioning (HVAC) systems, and especially to collection of event or operation data or information in HVAC systems.

Users of HVAC systems such as, by way of example and not by way of limitation, homeowners may prefer that only minimal information be displayed or otherwise presented to them to inform them of details regarding operation of the HVAC system. Too much information may be confusing or frustrating to a homeowner. Further, there is little need for a homeowner to remember when certain events may have occurred.

In contrast, greater detail of information regarding operation or events regarding the HVAC system-, including when events may have occurred, may be quite valuable to a serviceman seeking to diagnose or debug a problem. Generally speaking, the more information that may be made available regarding operation of an HVAC system, the easier it is to service the system, and the easier it is to develop improvements to the system.

The information is from a common system and may be collected at the same time, but it would be advantageous to present different presentations of the information—a less detailed version to a user, and a more detailed version to a serviceman or other professional.

There is a need for an apparatus and method for storing event information for an HVAC system that can present differing levels of information detail to different users.

### SUMMARY OF THE INVENTION

An apparatus for storing event information relating to operation of an HVAC system includes: (a) at least one memory controller coupled with the HVAC system for receiving the event information; and (b) at least one memory unit coupled with the at least one memory controller. A first memory unit of the at least one memory unit is configured for receiving first selected information of the event information for accessing by at least one of a first party and a second party. A second memory unit of the at least one memory unit is configured for receiving second selected information of the event information for accessing by the second party.

A method for storing event information relating to operation of an HVAC system includes: (a) providing at least one memory controller coupled with the HVAC system for receiving the event information; (b) providing at least one memory unit coupled with the at least one memory controller; (c) in no particular order: (1) configuring a first memory unit of the at least one memory unit for storing first selected information of the event; and (2) configuring a second memory unit of the at least one memory unit for storing second selected information of the event information; and (d) in no particular order: (1) operating the first memory unit for permitting access to the first selected information by at least one of a first party and a second party; and (2) operating the second memory unit for permitting access to the second selected information by the second party.

It is, therefore, a feature of the present invention to present an apparatus and method for storing event information for an HVAC system that can present differing levels of information detail to different users.

Further features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a schematic diagram of a first embodiment of the apparatus of the invention.

FIG. 2 is a flow chart illustrating treatment of event information in the embodiment of the apparatus illustrated in FIG. 1.

FIG. 3 is a schematic diagram of a second embodiment of the apparatus of the invention.

FIG. 4 is a flow chart illustrating treatment of event information in the embodiment of the apparatus illustrated in FIG. 3.

FIG. 5 is a flow diagram illustrating treatment of a reset event in the embodiment of the apparatus illustrated in FIG. 3.

FIG. 6 is a schematic diagram of a third embodiment of the apparatus of the invention.

FIG. 7 is a flow chart illustrating treatment of event information in a first buffer unit of the embodiment of the apparatus illustrated in FIG. 6.

FIG. 8 is a flow diagram illustrating treatment of a reset event in a first buffer unit of the embodiment of the apparatus illustrated in FIG. 6.

FIG. 9 is a flow chart illustrating treatment of event information in a second buffer unit of the embodiment of the apparatus illustrated in FIG. 6.

FIG. 10 is a flow diagram illustrating treatment of a reset event in a second buffer unit of the embodiment of the apparatus illustrated in FIG. 6.

### DETAILED DESCRIPTION

A new apparatus and method for storing and displaying operational event information such as, by way of example and not by way of limitation, error codes in an HVAC system involves having two memory buffers storing the event information. The HVAC system may be a communicating HVAC system included in a communicating HVAC network involving a plurality of HVAC systems. The present invention may be employed in some or all of the HVAC systems in an HVAC network.

Generally, a first buffer stores all operational information, such as by way of example and not by way of limitation, events, error codes or alarms present in the system. Each event may be identified with time stamping or storage may be effected in a chronological order. A further option may be to record consecutive, substantially identical events as one entry with an event counter associated with the entry to count the number of times the same event is consecutively presented.

A second buffer is preferably independent of the first buffer. The second buffer may store the same information that is stored in the first buffer. Time stamps or chronological storing may be employed in the second buffer. The second buffer substantially duplicates the information stored in the first buffer. However, information in the second buffer is preferably not reset when the primary buffer is reset. It may be advantageous to provide that the second buffer store any resetting of the primary buffer as an event. It is preferred that access to the second buffer be controlled to limit disclosure of information stored in the second buffer to authorized persons. Access to information stored in the second buffer may require use of a non-published, secret access code or another access control arrangement.

Either of the first and second buffers can store information in RAM (Random Access Memory) or in a non-volatile memory independently of each other. The first and second buffers may reside on the same HVAC system or may reside on different HVAC systems.

Preferably, both of the first and second buffers may be reset and cleared independently of each other by the person or an apparatus servicing the HVAC system or clearing of an individual device in an HVAC system in which the buffers may reside.

Buffer content for either of the first and second buffers preferably may be displayed in a human-readable form on any appropriate device in an HVAC system including, by way of example and not by way of limitation, a thermostat, zoning panel, furnace controller or any other control with a human-machine interface able to display information.

Buffer content may also be displayed on a remote device with human-machine interface such as a thermostat, home security panel, home automation panel, a personal digital assistant, a cellular phone, a wireless phone, a personal computer, a television set any other device connected to the HVAC system over a proprietary or common communicating interface such as wired or wireless Ethernet connection, Universal Serial Bus connection, RS-232 connection or other interface.

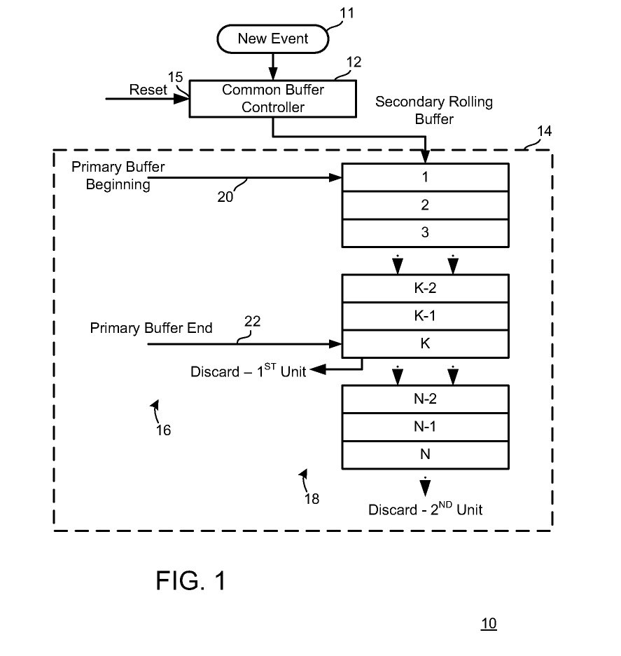

FIG. 1 is a schematic diagram of a first embodiment of the apparatus of the invention. In FIG. 1, an information storing system 10 for an HVAC (Heating Ventilating Air Conditioning) system includes a memory controller 12 and a memory section 14. Memory section 14 includes a first memory unit 16 and a second memory unit 18. Second memory unit 18 includes a plurality of memory sites 1, 2, 3, . . . K−2, K−1, K, . . . N−2, N−1, N. First memory unit 16 is a virtual memory unit having pointers 20, 22. Pointer 20 is a beginning pointer that remains pointed at memory site 1 to mark the beginning of first memory unit 16, so long as there is data stored in first memory unit 16. Pointer 22 is an ending pointer that points to the memory site containing the earliest-stored event within memory sites 1 through K.

Event data is provided to memory controller 12 from a host HVAC system (not shown in FIG. 1) via an event data input locus 11. Memory controller 12 also has a RESET locus 15 via which memory controller 12 may receive RESET signals. A RESET signal may cause memory controller 12 to move pointers 20, 22 to positions not indicating any data in second memory unit 18 is intended for consideration as being stored in first memory unit 16. Alternatively, memory controller 12 may respond to a RESET signal by eliminating one or both of pointers 20, 22 until needed to indicate that data in second memory unit 18 is intended for consideration as being stored in first memory unit 16.

First memory unit 16 operates as a rolling buffer memory unit, “bumping” event data or information to a next memory cell when new event data is received and stored. Thus, event data is stored on a first-in-first-out basis in first memory unit 16. First memory unit 16 discards event information after the event information is “bumped” from memory site K.

Second memory unit 18 also operates as a rolling buffer memory unit, “bumping” event data to a next memory cell when new event data is received and stored. Thus, event data is stored on a first-in-first-out basis in second memory unit 18. Second memory unit 18 keeps event data stored for a longer period than first memory unit 16. Second memory unit 18 keeps event data stored longer than it takes to fill memory site K. Second memory unit 18 discards event information after the event information is “bumped” from memory site N. N is greater than K.

In a preferred embodiment of HVAC system information store 10, pointers 20, 22 simply identify which memory sites 1 through K are included in first memory unit 16. However, not all information stored in memory sites 1 through K is to be regarded as stored in first memory unit 16. One may recall that the intent of first memory unit 16 is to provide less complex, less confusing information for a user, such as a homeowner. Thus, it is preferred that selected information stored in memory sites 1 through K, but not necessarily all information stored in memory sites 1 through K, may be regarded as stored in first memory unit 16 and may be displayed to a user without limiting access.

Events stored in information store 10 may include alarm events. Alarm events may be continuous alarms, occasion-based alarms or alarm clears. Continuous alarms may relate to a continuously monitored event such as an event indicated by a sensor. By way of example and not by way of limitation, a continuous alarm may relate to whether a particular window to a conditioned space is open. An occasion-based alarm may relate to an occurrence of a particular event such as, by way of example and not by way of limitation, failure by a control unit to achieve a requisite thermal condition to permit lighting a furnace. Thus, an event alarm may be entered or stored in information store 10 on each occasion of failure by a control unit to achieve a requisite thermal condition to permit lighting a furnace.

Information store 10 may also store circumstances generally occurring with an alarm, including by way of example and not by way of limitation, specified parameters extant when an alarm occurs, specified parameters extant shortly before an alarm occurs, specified parameters extant shortly after an alarm occurs or specified parameters during a time interval spanning a time at which an alarm occurs.

An alarm clear preferably identifies at least one earlier occurring alarm to which the alarm clear pertains. By way of example and not by way of limitation, an alarm clear may effect clearing of an earlier-occurring continuous alarm (e.g., indicating that a offending window has been closed). An alarm clear may effect clearing of all active or pending event alarms relating to a particular occasion or event that are identified by the alarm clear. By way of further example and not by way of limitation, upon successful lighting of a furnace an alarm clear may be or stored in information store 10 to effect clearing of all active or pending alarms relating to each occasion of failure by a control unit to achieve a requisite thermal condition to permit lighting a furnace.

It is preferred that first memory unit 16 and second memory unit 18 be embodied in a non-volatile type memory device or unit. A volatile memory unit such as, by way of example and not by way of limitation, a Random Access Memory (RAM) memory unit may be employed when it is desired that information stored in a memory device be erased or otherwise removed or lost whenever the volatile memory device or unit is reset.

By way of example and not by way of limitation, events entered into first memory unit 16 may be provided upon the occasion of resetting a short-term RAM device for storing events (not shown in FIG. 1; understood by those skilled in the art of memory system design). Using such an arrangement, events may be first entered into a RAM memory unit substantially upon their respective occurrences, and whenever the RAM memory unit is reset or otherwise cleared, entries in the RAM memory unit are first transferred to first memory unit 16 before being removed from the RAM memory unit. By way of example and not by way of limitation, a RAM memory unit may be cleared in response to a clearing action by a user, a clearing action by a repair person or in response to another event.

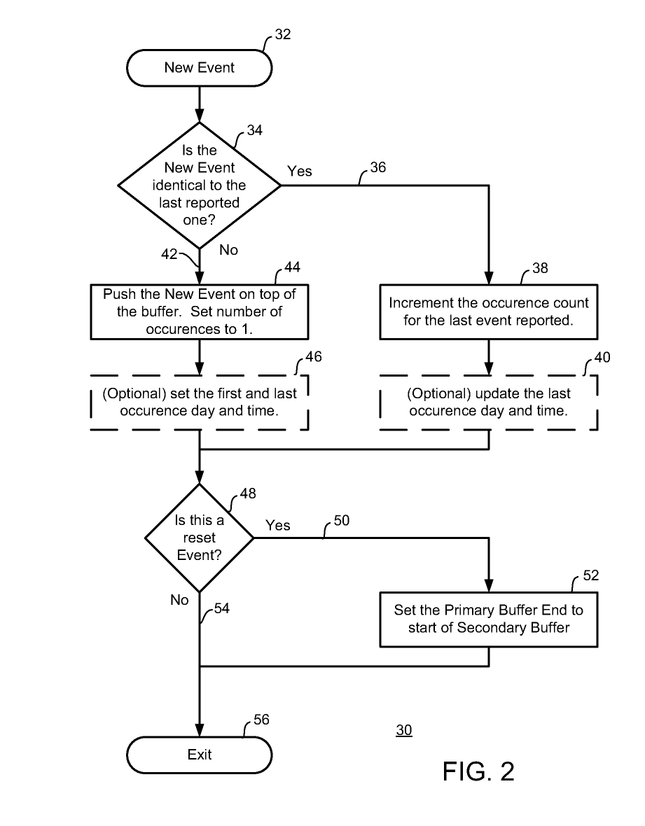

FIG. 2 is a flow chart illustrating treatment of event information in the embodiment of the apparatus illustrated in FIG. 1. In FIG. 2, a treatment protocol 30 begins with the occurrence of a new event, as indicated by a beginning locus 32.

Treatment protocol 30 continues by posing a query whether the new event being treated is substantially identical to the last reported event, as indicated by a query block 34. If the new event is substantially identical to the last reported event, treatment protocol 30 continues from query block 34 via a YES response line 36 and an occurrence count for the last event reported is incremented, as indicated by a block 38. Maintaining an incremented count for tracking substantially identical occurrences is a treatment step that permits counting occurrences while conserving memory. Alternatively, each separate occurrence may be accounted for using a separate memory entry and no occurrence count may be required.

Treatment protocol 30 continues by updating the recorded day and time of occurrence of the latest-to-occur similar event, as indicated by a block 40. Updating the recorded day and time of occurrence of the latest-to-occur similar event may be an optional treatment step, as indicated by the broken line format of block 40. If an alternate design is employed in which a separate occurrence is accounted for using a separate memory entry, a date and time entry may accompany the event notation in storage and no updating of the day and time of occurrence of the latest-to-occur similar event may be required.

If the new event is not substantially identical to the last reported event, treatment protocol 30 continues from query block 34 via a NO response line 42 and a record of the occurrence of the new event is pushed to the top of a memory buffer, as indicated by a block 44. When the record of the occurrence of the new event is pushed to the top of a memory buffer, a count indicating occurrence of the new event may be set to 1, as also indicated by block 44. Treatment protocol 30 may continue by setting the first and last occurrence day and time entries for the new event, as indicated by a block 46. Setting the first and last occurrence day and time entries for the new event may be an optional treatment step, as indicated by the broken line format of block 46.

Treatment protocol 30 may continue from block 40 or from block 46 by posing a query whether the new event being treated is a reset event, as indicated by a query block 48. If the new event is a reset event, treatment protocol 30 continues from query block 48 via a YES response line 50 and the primary buffer end (see element 22; FIG. 1) is set to the primary buffer beginning (see element 20; FIG. 1) at the beginning of the secondary buffer (see second memory unit 18; FIG. 1), as indicated by a block 52. Treatment protocol 30 proceeds from block 52 to an exit locus 56. If the new event is not a reset event, treatment protocol 30 continues from query block 48 via a NO response line 54 to exit locus 56.

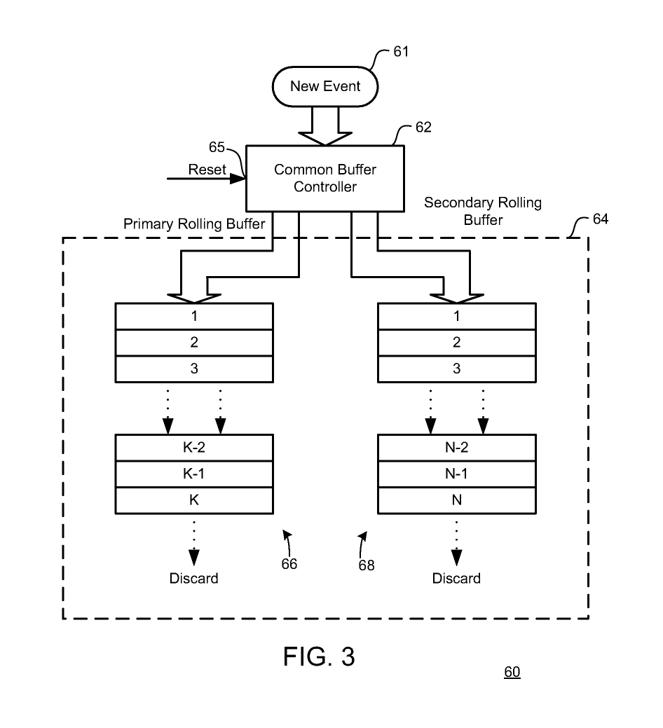

FIG. 3 is a schematic diagram of a second embodiment of the apparatus of the invention. In FIG. 3, an information storing system or information store 60 for an HVAC (Heating Ventilating Air Conditioning) system includes a common memory controller 62 and a memory section 64. Memory section 64 includes a first memory unit 66 and a second memory unit 68. First memory unit 66 includes a plurality of memory sites 1, 2, 3, . . . K−2, K−1, K. Second memory unit 68 includes a plurality of memory sites 1, 2, 3, . . . N−2, N−1, N.

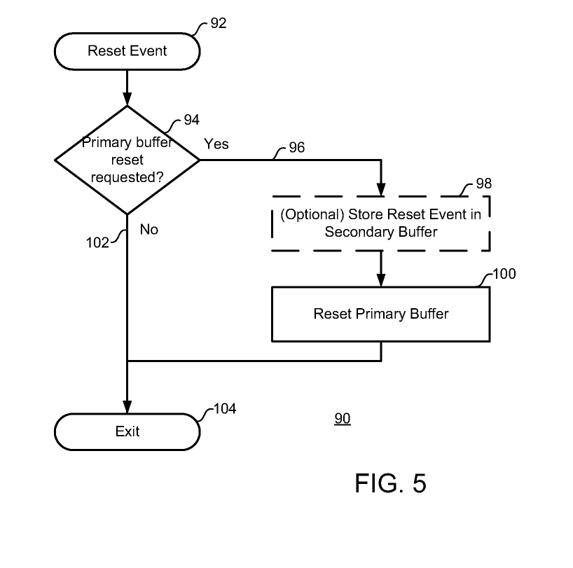

Event data is provided to memory controller 62 from a host HVAC system (not shown in FIG. 3) via an event data input locus 61. Memory controller 62 also has a RESET locus 65 via which memory controller 62 may receive RESET signals. A RESET signal may cause memory controller 62 to reset or erase entries in first memory unit 66 or to otherwise empty first memory unit 66. Response by information storing system 60 to a RESET signal is described in greater detail in connection with FIG. 5.

First memory unit 66 operates as a rolling buffer memory unit, “bumping” event data or information to a next memory cell when new event data is received and stored. Thus, event data is stored on a first-in-first-out basis in first memory unit 66. First memory unit 66 discards event information after the event information is “bumped” from memory site K.

Second memory unit 68 also operates as a rolling buffer memory unit, “bumping” event data to a next memory cell when new event data is received and stored. Thus, event data is stored on a first-in-first-out basis in second memory unit 68. Second memory unit 68 keeps event data stored for a longer period than first memory unit 66. Second memory unit 68 discards event information after the event information is “bumped” from memory site N. N is greater than K.

In a preferred embodiment of HVAC system information store 60, not all information stored in first memory unit 66 in memory sites 1 through K is the same information stored in second memory unit 68 in memory sites 1 through K, or in memory sites K+1 through N. One may recall that the intent of first memory unit 66 is to provide less complex, less confusing information for a user, such as a homeowner. Thus, it is preferred that selected information stored in first memory unit 66 in memory sites 1 through K may contain fewer data entries than information stored in second memory unit 68 in memory sites 1 through K, and in memory sites K+1 through N.

Events stored in information store 60 may include alarm events. Alarm events may be continuous alarms, occasion-based alarms or alarm clears. Continuous alarms may relate to a continuously monitored event such as an event indicated by a sensor. By way of example and not by way of limitation, a continuous alarm may relate to whether a particular window to a conditioned space is open. An occasion-based alarm may relate to an occurrence of a particular event such as, by way of example and not by way of limitation, failure by a control unit to achieve a requisite thermal condition to permit lighting a furnace. Thus, an event alarm may be entered or stored in information store 60 on each occasion of failure by a control unit to achieve a requisite thermal condition to permit lighting a furnace.

Information store 60 may also store circumstances generally occurring with an alarm, including by way of example and not by way of limitation, specified parameters extant when an alarm occurs, specified parameters extant shortly before an alarm occurs, specified parameters extant shortly after an alarm occurs or specified parameters during a time interval spanning a time at which an alarm occurs.

An alarm clear preferably identifies at least one earlier occurring alarm to which the alarm clear pertains. By way of example and not by way of limitation, an alarm clear may effect clearing of an earlier-occurring continuous alarm (e.g., indicating that a offending window has been closed). An alarm clear may effect clearing of all active or pending event alarms relating to a particular occasion or event that are identified by the alarm clear. By way of further example and not by way of limitation, upon successful lighting of a furnace an alarm clear may be or stored in information store 60 to effect clearing of all active or pending alarms relating to each occasion of failure by a control unit to achieve a requisite thermal condition to permit lighting a furnace.

It is preferred that first memory unit 66 and second memory unit 68 be embodied in a non-volatile type memory device or unit. A volatile memory unit such as, by way of example and not by way of limitation, a Random Access Memory (RAM) memory unit may be employed when it is desired that information stored in a memory device be erased or otherwise removed or lost whenever the volatile memory device or unit is reset.

By way of example and not by way of limitation, events entered into first memory unit 66 may be provided upon the occasion of resetting a short-term RAM device for storing events (not shown in FIG. 3; understood by those skilled in the art of memory system design). Using such an arrangement, events may be first entered into a RAM memory unit substantially upon their respective occurrences, and whenever the RAM memory unit is reset or otherwise cleared, entries in the RAM memory unit are first transferred to first memory unit 66 before being removed from the RAM memory unit. By way of example and not by way of limitation, a RAM memory unit may be cleared in response to a clearing action by a user, a clearing action by a repair person or in response to another event.

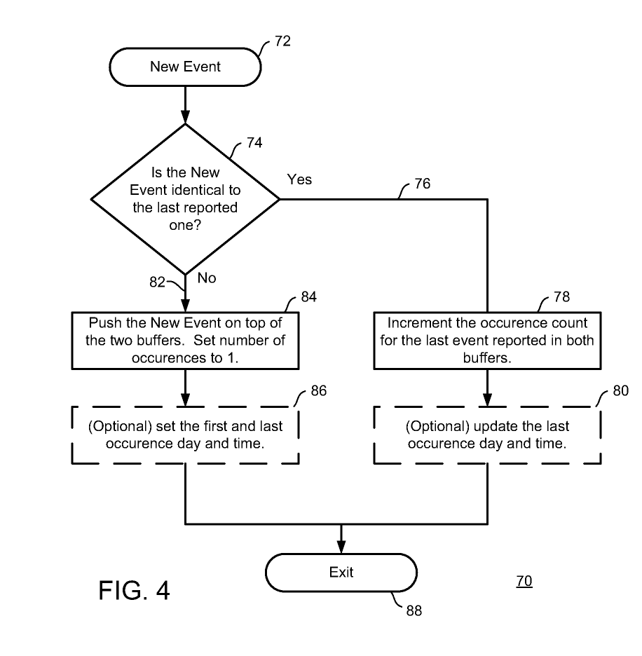

FIG. 4 is a flow chart illustrating treatment of event information in the embodiment of the apparatus illustrated in FIG. 3. In FIG. 4, a treatment protocol 70 begins with the occurrence of a new event, as indicated by a beginning locus 72.

Treatment protocol 70 continues by posing a query whether the new event being treated is substantially identical to the last reported event, as indicated by a query block 74. If the new event is substantially identical to the last reported event, treatment protocol 70 continues from query block 74 via a YES response line 76 and an occurrence count for the last event reported is incremented in both memory units 66, 68 (FIG. 3), as indicated by a block 78. Maintaining an incremented count for tracking substantially identical occurrences is a treatment step that permits counting occurrences while conserving memory. Alternatively, each separate occurrence may be accounted for using a separate memory entry and no occurrence count may be required.

Treatment protocol 70 continues by updating the recorded day and time of occurrence of the latest-to-occur similar event, as indicated by a block 80. Updating the recorded day and time of occurrence of the latest-to-occur similar event may be an optional treatment step, as indicated by the broken line format of block 80. If an alternate design is employed in which a separate occurrence is accounted for using a separate memory entry, a date and time entry may accompany the event notation in storage and no updating of the day and time of occurrence of the latest-to-occur similar event may be required.

If the new event is not substantially identical to the last reported event, treatment protocol 70 continues from query block 74 via a NO response line 82 and a record of the occurrence of the new event is pushed to the top of both memory units 66, 68, as indicated by a block 84. When the record of the occurrence of the new event is pushed to the top of both memory units 66, 68, a count indicating occurrence of the new event may be set to 1, as also indicated by block 84. Treatment protocol 70 may continue by setting the first and last occurrence day and time entries for the new event, as indicated by a block 86. Setting the first and last occurrence day and time entries for the new event may be an optional treatment step, as indicated by the broken line format of block 86.

Treatment protocol 30 may continue from block 80 or from block 86 to an exit locus 88.

FIG. 5 is a flow diagram illustrating treatment of a reset event in the embodiment of the apparatus illustrated in FIG. 3. In FIG. 5, a treatment protocol 90 begins with the occurrence of a reset event, as indicated by a beginning locus 92. A reset event may occur, by way of example and not by way of limitation, when a RESET signal or other RESET indication is received at a RESET locus (e.g., RESET locus 65; FIG. 3). A reset event may cause a resetting or erasing of entries in a memory unit or may otherwise empty a memory unit.

Treatment protocol 90 continues by posing a query whether a resetting of a primary buffer (e.g., first memory unit 66; FIG. 3) is being requested, as indicated by a query block 94. If a resetting of a primary buffer is being requested, treatment protocol 90 continues from query block 94 via a YES response line 96 information relating to the reset event is stored in the secondary buffer (e.g., second memory unit 68; FIG. 3), as indicated by a block 98. Such related information to be stored may include, by way of example and not by way of limitation, the occurrence of a reset event, and the date and time of the occurrence. Storing information relating to the reset event may be an optional treatment step, as indicated by the broken line format of block 98.

Treatment protocol 90 may continue by resetting the primary buffer (e.g., first memory unit 66; FIG. 3), as indicated by a block 100. Treatment protocol 90 may continue from block 100 to an exit locus 104.

If a resetting of a primary buffer is not being requested, treatment protocol 90 continues from query block 94 via a NO response line 102 to exit locus 104.

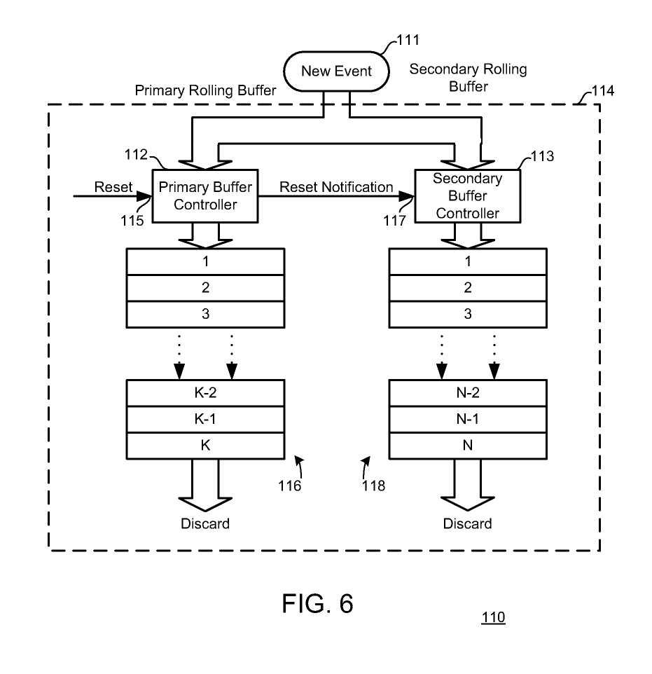

FIG. 6 is a schematic diagram of a third embodiment of the apparatus of the invention. In FIG. 6, an information storing system 110 for an HVAC (Heating Ventilating Air Conditioning) system includes a first memory controller 112, a second memory controller 113 and a memory section 114. Memory section 114 includes a first memory unit 116 and a second memory unit 118. First memory unit 116 includes a plurality of memory sites 1, 2, 3, . . . K−2, K−1, K. Second memory unit 118 includes a plurality of memory sites 1, 2, 3, . . . N−2, N−1, N.

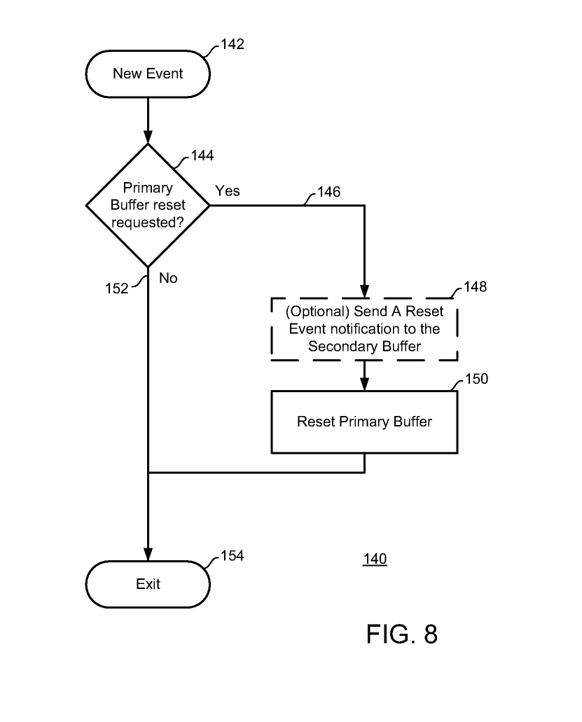

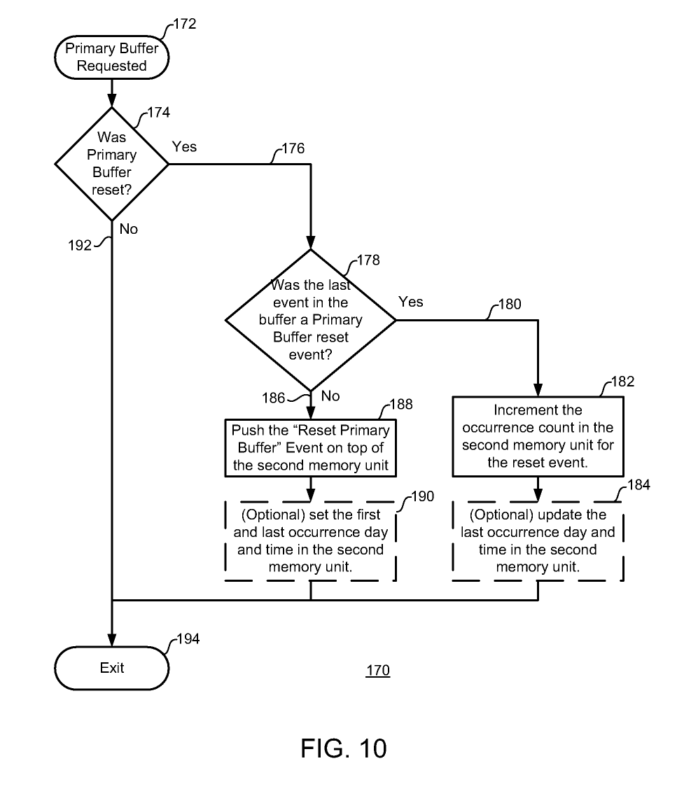

Event data is provided to memory controllers 112, 113 from a host HVAC system (not shown in FIG. 6) via an event data input locus 111. Memory controller 112 has a RESET locus 115 via which memory controller 112 may receive RESET signals. A RESET signal may cause memory controller 112 to reset or erase entries in first memory unit 116 or to otherwise empty first memory unit 116. Memory controller 113 has a RESET locus 117 via which memory controller 113 may receive indications of RESET signals received by memory controller 112. In an alternate arrangement, RESET locus 117 may be coupled with RESET locus 115. A RESET signal may cause memory controller 112 to reset or erase entries in first memory unit 116 or to otherwise empty first memory unit 116. Response by information storing system 110 to a RESET signal is described in greater detail in connection with FIGS. 8 and 10.

First memory unit 116 operates as a rolling buffer memory unit, “bumping” event data or information to a next memory cell when new event data is received and stored. Thus, event data is stored on a first-in-first-out basis in first memory unit 116. First memory unit 116 discards event information after the event information is “bumped” from memory site K.

Second memory unit 118 also operates as a rolling buffer memory unit, “bumping” event data to a next memory cell when new event data is received and stored. Thus, event data is stored on a first-in-first-out basis in second memory unit 118. Second memory unit 118 keeps event data stored for a longer period than first memory unit 116. Second memory unit 118 discards event information after the event information is “bumped” from memory site N. N is greater than K.

In a preferred embodiment of HVAC system information store 110, not all information stored in first memory unit 116 in memory sites 1 through K is the same information stored in second memory unit 118 in memory sites 1 through K, or in memory sites K+1 through N. One may recall that the intent of first memory unit 116 is to provide less complex, less confusing information for a user, such as a homeowner. Thus, it is preferred that selected information stored in first memory unit 116 in memory sites 1 through K may contain fewer data entries than information stored in second memory unit 118 in memory sites 1 through K, and in memory sites K+1 through N.

Events stored in information store 10 may include alarm events. Alarm events may be continuous alarms, occasion-based alarms or alarm clears. Continuous alarms may relate to a continuously monitored event such as an event indicated by a sensor. By way of example and not by way of limitation, a continuous alarm may relate to whether a particular window to a conditioned space is open. An occasion-based alarm may relate to an occurrence of a particular event such as, by way of example and not by way of limitation, failure by a control unit to achieve a requisite thermal condition to permit lighting a furnace. Thus, an event alarm may be entered or stored in information store 110 on each occasion of failure by a control unit to achieve a requisite thermal condition to permit lighting a furnace.

Information store 110 may also store circumstances generally occurring with an alarm, including by way of example and not by way of limitation, specified parameters extant when an alarm occurs, specified parameters extant shortly before an alarm occurs, specified parameters extant shortly after an alarm occurs or specified parameters during a time interval spanning a time at which an alarm occurs.

An alarm clear preferably identifies at least one earlier occurring alarm to which the alarm clear pertains. By way of example and not by way of limitation, an alarm clear may effect clearing of an earlier-occurring continuous alarm (e.g., indicating that a offending window has been closed). An alarm clear may effect clearing of all active or pending event alarms relating to a particular occasion or event that are identified by the alarm clear. By way of further example and not by way of limitation, upon successful lighting of a furnace an alarm clear may be or stored in information store 10 to effect clearing of all active or pending alarms relating to each occasion of failure by a control unit to achieve a requisite thermal condition to permit lighting a furnace.

It is preferred that first memory unit 116 and second memory unit 118 be embodied in a non-volatile type memory device or unit. A volatile memory unit such as, by way of example and not by way of limitation, a Random Access Memory (RAM) memory unit may be employed when it is desired that information stored in a memory device be erased or otherwise removed or lost whenever the volatile memory device or unit is reset.

By way of example and not by way of limitation, events entered into first memory unit 116 may be provided upon the occasion of resetting a short-term RAM device for storing events (not shown in FIG. 6; understood by those skilled in the art of memory system design). Using such an arrangement, events may be first entered into a RAM memory unit substantially upon their respective occurrences, and whenever the RAM memory unit is reset or otherwise cleared, entries in the RAM memory unit are first transferred to first memory unit 116 before being removed from the RAM memory unit. By way of example and not by way of limitation, a RAM memory unit may be cleared in response to a clearing action by a user, a clearing action by a repair person or in response to another event.

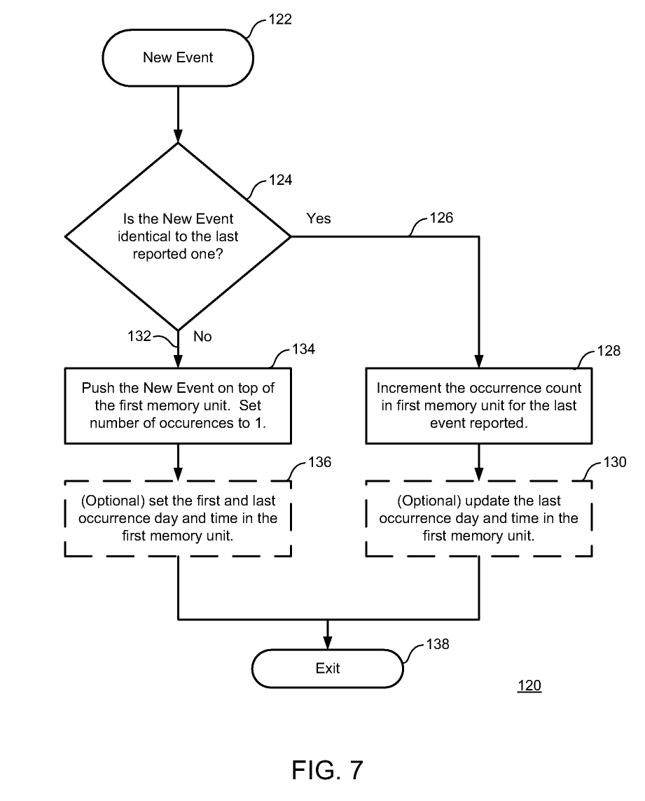

FIG. 7 is a flow chart illustrating treatment of event information in a first buffer unit of the embodiment of the apparatus illustrated in FIG. 6. In FIG. 7, a treatment protocol 120 begins with the occurrence of a new event, as indicated by a beginning locus 122.

Treatment protocol 120 continues by posing a query whether the new event being treated is substantially identical to the last reported event, as indicated by a query block 124. If the new event is substantially identical to the last reported event, treatment protocol 120 continues from query block 124 via a YES response line 126 and an occurrence count for the last event reported is incremented in first memory unit 116 (FIG. 6), as indicated by a block 128. Maintaining an incremented count for tracking substantially identical occurrences is a treatment step that permits counting occurrences while conserving memory. Alternatively, each separate occurrence may be accounted for using a separate memory entry and no occurrence count may be required.

Treatment protocol 120 continues by updating the recorded day and time of occurrence of the latest-to-occur similar event, as indicated by a block 130. Updating the recorded day and time of occurrence of the latest-to-occur similar event may be an optional treatment step, as indicated by the broken line format of block 130. If an alternate design is employed in which a separate occurrence is accounted for using a separate memory entry, a date and time entry may accompany the event notation in storage and no updating of the day and time of occurrence of the latest-to-occur similar event may be required.

If the new event is not substantially identical to the last reported event, treatment protocol 120 continues from query block 124 via a NO response line 132 and a record of the occurrence of the new event is pushed to the top of first memory units 116, as indicated by a block 134. When the record of the occurrence of the new event is pushed to the top of first memory unit 116, a count indicating occurrence of the new event may be set to 1, as also indicated by block 134. Treatment protocol 120 may continue by setting the first and last occurrence day and time entries for the new event, as indicated by a block 136. Setting the first and last occurrence day and time entries for the new event may be an optional treatment step, as indicated by the broken line format of block 136.

Treatment protocol 120 may continue from block 130 or from block 136 to an exit locus 138.

FIG. 8 is a flow diagram illustrating treatment of a reset event in a first buffer unit of the embodiment of the apparatus illustrated in FIG. 6. In FIG. 8, a treatment protocol 140 begins with the occurrence of a reset event, as indicated by a beginning locus 142. A reset event may occur, by way of example and not by way of limitation, when a RESET signal or other RESET indication is received at a RESET locus (e.g., RESET locus 115; FIG. 6). A reset event may cause a resetting or erasing of entries in a memory unit or may otherwise empty a memory unit.

Treatment protocol 140 continues by posing a query whether a resetting of a primary buffer (e.g., first memory unit 116; FIG. 6) is being requested, as indicated by a query block 144. If a resetting of a primary buffer is being requested, treatment protocol 140 continues from query block 144 via a YES response line 146 information relating to the reset event is stored in the secondary buffer (e.g., second memory unit 118; FIG. 3), as indicated by a block 148. Such related information to be stored may include, by way of example and not by way of limitation, the occurrence of a reset event, and the date and time of the occurrence. Storing information relating to the reset event may be an optional treatment step, as indicated by the broken line format of block 148.

Treatment protocol 140 may continue by resetting the primary buffer (e.g., first memory unit 116; FIG. 6), as indicated by a block 150. Treatment protocol 140 may continue from block 150 to an exit locus 154.

If a resetting of a primary buffer is not being requested, treatment protocol 140 continues from query block 144 via a NO response line 152 to exit locus 154.

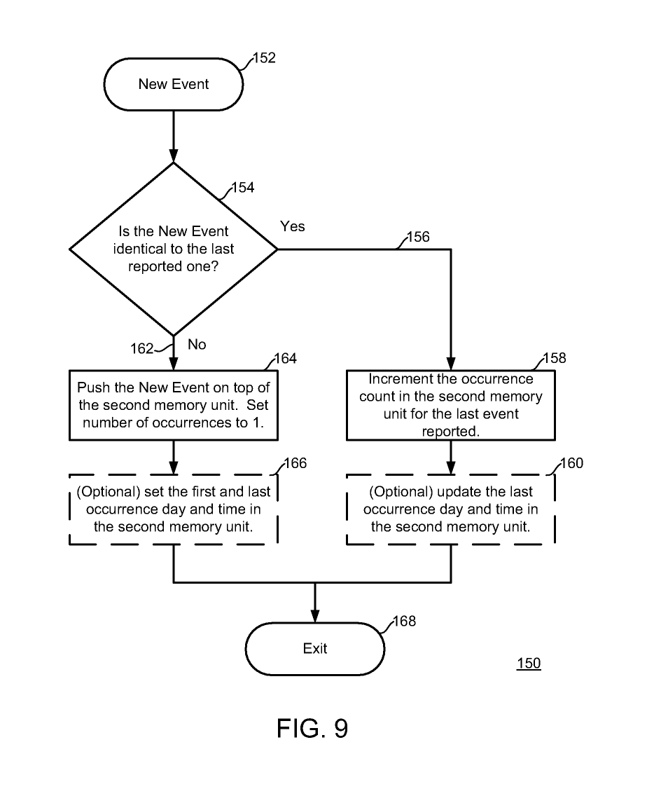

FIG. 9 is a flow chart illustrating treatment of event information in a second buffer unit of the embodiment of the apparatus illustrated in FIG. 6. In FIG. 9, a treatment protocol 150 begins with the occurrence of a new event, as indicated by a beginning locus 152.

Treatment protocol 150 continues by posing a query whether the new event being treated is substantially identical to the last reported event, as indicated by a query block 154. If the new event is substantially identical to the last reported event, treatment protocol 150 continues from query block 154 via a YES response line 156 and an occurrence count for the last event reported is incremented in second memory unit 118 (FIG. 6), as indicated by a block 158. Maintaining an incremented count for tracking substantially identical occurrences is a treatment step that permits counting occurrences while conserving memory. Alternatively, each separate occurrence may be accounted for using a separate memory entry and no occurrence count may be required.

Treatment protocol 150 continues by updating the recorded day and time of occurrence of the latest-to-occur similar event, as indicated by a block 160. Updating the recorded day and time of occurrence of the latest-to-occur similar event may be an optional treatment step, as indicated by the broken line format of block 160. If an alternate design is employed in which a separate occurrence is accounted for using a separate memory entry, a date and time entry may accompany the event notation in storage and no updating of the day and time of occurrence of the latest-to-occur similar event may be required.

If the new event is not substantially identical to the last reported event, treatment protocol 150 continues from query block 154 via a NO response line 162 and a record of the occurrence of the new event is pushed to the top of second memory unit 118, as indicated by a block 164. When the record of the occurrence of the new event is pushed to the top of second memory unit 118, a count indicating occurrence of the new event may be set to 1, as also indicated by block 164. Treatment protocol 150 may continue by setting the first and last occurrence day and time entries for the new event, as indicated by a block 166. Setting the first and last occurrence day and time entries for the new event may be an optional treatment step, as indicated by the broken line format of block 166.

Treatment protocol 150 may continue from block 160 or from block 166 to an exit locus 168.

FIG. 10 is a flow diagram illustrating treatment of a reset event in a second buffer unit of the embodiment of the apparatus illustrated in FIG. 6. In FIG. 10, a treatment protocol 170 begins with the occurrence of a reset event requesting reset of a primary buffer (e.g., first memory unit 116; FIG. 6), as indicated by a beginning locus 172.

Treatment protocol 170 continues by posing a query whether the primary buffer was reset, as indicated by a query block 174. If the primary buffer was reset, treatment protocol 170 continues from query block 174 via a YES response line 176 and poses a query whether the last event was a primary buffer reset event, as indicated by a query block 178.

If the last event was a primary buffer reset event, treatment protocol 170 continues from query block 178 via a YES response line 180 and an occurrence count for the last reset event reported is incremented in second memory unit 118 (FIG. 6), as indicated by a block 182. Maintaining an incremented count for tracking substantially identical occurrences, such as reset events, is a treatment step that permits counting occurrences while conserving memory. Alternatively, each separate reset event occurrence may be accounted for using a separate memory entry and no reset event occurrence count may be required.

Treatment protocol 170 continues by updating the recorded day and time of the latest-to-occur reset event, as indicated by a block 184. Updating the recorded day and time of occurrence of the latest-to-occur reset event may be an optional treatment step, as indicated by the broken line format of block 184. If an alternate design is employed in which a separate reset event occurrence is accounted for using a separate memory entry, a date and time entry may accompany the reset event notation in storage and no updating of the day and time of the latest-to-occur reset event may be required.

If the last event was not a primary buffer reset event, treatment protocol 170 continues from query block 178 via a NO response line 186 a record of the “Reset Primary Buffer” event is pushed to the top of second memory unit 118 (FIG. 6), as indicated by a block 188. When the record of the occurrence of the “Reset Primary Buffer” event is pushed to the top of second memory unit 118, a count indicating occurrence of the “Reset Primary Buffer” event may be set to 1. Treatment protocol 170 may continue by setting the first and last occurrence day and time entries for the “Reset Primary Buffer” event, as indicated by a block 190. Setting the first and last occurrence day and time entries for the “Reset Primary Buffer” event may be an optional treatment step, as indicated by the broken line format of block 190.

If the primary buffer was not reset, treatment protocol 170 continues from query block 174 via a NO response line 192. Treatment protocol 170 may continue from query block 174 via a NO response line 192 or from block 184 to an exit locus 194.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following claims:

I claim:

1. An apparatus for storing event information relating to operation of an HVAC system; the apparatus comprising:
(a) at least one memory controller coupled with said HVAC system for receiving said event information; and
(b) at least one memory unit coupled with said at least one memory controller;
a first memory unit of said at least one memory unit being configured for receiving first selected information of said event information for accessing by at least one of a first party and a second party; a second memory unit of said at least one memory unit being configured for receiving second selected information of said event information for accessing by said second party.

2. An apparatus for storing event information relating to operation of an HVAC system as recited in claim 1 wherein said second party is a servicing party, and wherein said accessing said second selected information is a controlled accessing.

3. An apparatus for storing event information relating to operation of an HVAC system as recited in claim 1 wherein said second selected information is more detailed than said first selected information.

4. An apparatus for storing event information relating to operation of an HVAC system as recited in claim 1 wherein said second memory unit is a rolling buffer unit storing a limited number of most-recently received entries of said event information.

5. An apparatus for storing event information relating to operation of an HVAC system as recited in claim 4 wherein said first memory unit is a virtual rolling buffer unit including pointers; said pointers pointing to a subset of information contained in said limited number of most-recently received entries.

6. An apparatus for storing event information relating to operation of an HVAC system as recited in claim 5 wherein said subset of information is contained in a smaller number of said most-recently received entries than said limited number.

7. An apparatus for storing event information relating to operation of an HVAC system as recited in claim 1 wherein said at least one memory controller is a common memory controller coupled with said first memory unit and said second memory unit, wherein said first memory unit is a first rolling buffer unit storing a first limited number of most-recently received entries of selected information items of said event information, and wherein said second memory unit is a second rolling buffer unit storing a second limited number of most-recently received entries of said event information.

8. An apparatus for storing event information relating to operation of an HVAC system as recited in claim 1 wherein said at least one memory controller is a first memory controller coupled with said first memory unit and a second memory controller coupled with said second memory unit, wherein said first memory unit is a first rolling buffer unit storing a first limited number of most-recently received entries of selected information items of said event information, and wherein said second memory unit is a second rolling buffer unit storing a second limited number of most-recently received entries of said event information.

9. An apparatus for storing event information relating to operation of an HVAC system as recited in claim 6 wherein said second party is a servicing party, and wherein said accessing said second selected information is a controlled accessing.

10. An apparatus for storing event information relating to operation of an HVAC system as recited in claim 7 wherein said second party is a servicing party, and wherein said accessing said second selected information is a controlled accessing.

11. An apparatus for storing event information relating to operation of an HVAC system as recited in claim 8 wherein said second party is a servicing party, and wherein said accessing said second selected information is a controlled accessing.

12. An apparatus storing operating information relating to a communicating control system; the apparatus comprising:
(a) at least one controller unit coupled with said communicating control system;
and
(b) a memory unit coupled with said at least one controller unit;
said memory unit including a first memory device and a second memory device; said first memory device being configured for storing first selected information of said operational information; said second memory device being configured for storing second selected information of said operational information; said first memory device being configured for permitting access to said first selected information without restriction; said second memory device permitting only authorized access to said second selected information.

13. An apparatus storing operational information relating to a communicating control system as recited in claim 12 wherein said first memory device is a virtual rolling buffer unit including pointers; said pointers pointing to a subset of information contained in said second selected information; said second memory device being a rolling buffer unit; said second selected information being a limited number of most-recently received entries of said operational information.

14. An apparatus storing operational information relating to a communicating control system as recited in claim 12 wherein said at least one controller unit is a common memory controller coupled with said first memory device and said second memory device, wherein said first memory device is a first rolling buffer unit, and wherein said second memory device is a second rolling buffer unit; said first selected information being a first limited number of a portion of most-recently received entries of said operational information; said second selected information being a second limited number of most-recently received entries of said operational information.

15. An apparatus storing operational information relating to a communicating control system as recited in claim 12 wherein said at least one controller unit is a first memory controller coupled with said first memory device and a second memory controller coupled with said second memory device, wherein said first memory device is a first rolling buffer unit and said second memory device is a second rolling buffer unit; said first selected information being a first limited number of a portion of most-recently received entries of said operational information; said second selected information being a second limited number of most-recently received entries of said operational information.

16. A method for storing event information relating to operation of an HVAC system; the method comprising:
(a) providing at least one memory controller coupled with said HVAC system for receiving said event information;
(b) providing at least one memory unit coupled with said at least one memory controller;
(c) in no particular order:
(1) configuring a first memory unit of said at least one memory unit for storing first selected information of said event; and
(2) configuring a second memory unit of said at least one memory unit for storing second selected information of said event information; and
(d) in no particular order:
(1) operating said first memory unit for permitting access to said first selected information by at least one of a first party and a second party; and
(2) operating said second memory unit for permitting access to said second selected information by said second party.

17. A method for storing event information relating to operation of an HVAC system as recited in claim 16 wherein said first memory unit is a virtual rolling buffer unit including pointers; said pointers pointing to a subset of information contained in said second selected information; said second memory unit being a rolling buffer unit; said second selected information being a limited number of most-recently received entries of said event information.

18. A method for storing event information relating to operation of an HVAC system as recited in claim 16 wherein said at least one memory controller is a common memory controller coupled with said first memory unit and said second memory unit, wherein said first memory unit is a first rolling buffer unit, and wherein said second memory unit is a second rolling buffer unit; said first selected information being a first limited number of a portion of most-recently received entries of said event information; said second selected information being a second limited number of most-recently received entries of said event information.

19. A method for storing event information relating to operation of an HVAC system as recited in claim 16 wherein said at least one memory controller is a first memory controller coupled with said first memory unit and a second memory controller coupled with said second memory unit, wherein said first memory unit is a first rolling buffer unit and said second memory unit is a second rolling buffer unit; said first selected information being a first limited number of a portion of most-recently received entries of said event information; said second selected information being a second limited number of most-recently received entries of said event information.

20. A method for storing event information relating to operation of an HVAC system as recited in claim 16 wherein said second party is a servicing party, and wherein said accessing said second selected information is a controlled accessing.
